(19) United States
(12) Patent Application Publication
(10) Pub. No.: US 2005/0275241 A1
(43) Pub. Date: Dec. 15, 2005

(54) Vehicle load protection pad

(76) Inventor: Bruce Rothwell, Thousand Oaks, CA (US)

Correspondence Address: KELLY LOWRY & KELLEY, LLP, 6320 CANOGA AVENUE, SUITE 1650, WOODLAND HILLS, CA, 91367, US

(21) Appl. No.: 10/868,709

(22) Filed: Jun. 14, 2004

(51) Int. Cl. B60R 13/02

(52) U.S. Cl. 296/136.01

(57) ABSTRACT

A vehicle load protection pad includes an elongated, resiliently deformable body, a flexible mat attached to the body, and a plurality of magnets disposed within the mat for attaching the body to a surface of a vehicle. The flexible mat includes at least one flap having at least some of the magnets disposed therein and at least one fold in the mat to accommodate bending the flap. The flexible mat includes a base attached to the deformable body, and two flaps located on opposite sides of the base with folds in the mat between the base and each flap. The magnets are distributed in staggered positions within each flap.

### BACKGROUND OF THE INVENTION

The present invention generally relates to protective covers. More particularly, the present invention relates to vehicle load protection pads.

One problem relating to protecting the surface of a vehicle occurs when someone is working on a vehicle, such as an automobile or a truck. The tools used to work on the vehicle may scratch or mar the surface(s) of the vehicle. Another problem relating to protecting the surface of a vehicle occurs when someone is hauling loads. As the loads being transported, they may also scratch or mar the surface(s) of the vehicle. For example, the vehicle may hit a bump or pothole in the road and the load may be temporarily lifted only to come down hard and possibly shift. Yet another problem relating to protecting the surface of a vehicle occurs when dirt, liquids or other contaminants come in contact with the surface of the vehicle. It is also common for the hands of the person working on the vehicle to become dirty with grease or oil and for that substance to be transferred to the hood or sides of the vehicle. In this regard, it has been known in the art to place a cloth or other material over the vehicle in order to prevent this type of damage.

Many different types of fender covers have been employed to protect the surface of a motor vehicle from damage caused by objects and individuals brushing against such surfaces. For example, U.S. Pat. No. 4,849,272 discloses a magnetically securable fender cover apparatus. However, the fender cover merely provides a thin layer of protection that does little to soften the impact of a heavy object slamming against the cover. In another example, U.S. Pat. No. 5,129,695 discloses a vehicle side protector. However, this side protector requires straps to be held in position and, if not for the straps, would otherwise fall off the side of the vehicle during its contemplated use if struck with an object.

While protective covers such as those described above may provide means of providing protection from objects and individuals, such protective covers can always be improved to provide greater protection and more adaptive connection to the surface of a vehicle.

Accordingly, there is a need for a protective cover which is adapted to be attached to a vehicle surface to be protected. Preferably, the protective cover would advantageously utilize magnets to facilitate attachment to the surface of a vehicle. There is also a need for a protective cover that is portable and easy to set up, and is adaptable to protect a number of different surfaces at various locations on a vehicle. Moreover, there is a need for such a protective cover which is adapted to protect surfaces from the impacts of heavy loads. The present invention satisfies these needs and provides other related advantages.

### SUMMARY OF THE INVENTION

The present invention is directed to a protective pad which is adapted to be attached to the surface of an object to be protected by the use of magnets. One possible use for the pad is to protect the roof of the cab of a pickup truck or to protect the upper edge of the truck's tailgate. The shape of the pad can be adapted to overlie the area to be protected. The pad could also be used with or as a car top carrier that would receive skis, a snowboard or the like.

In accordance with an embodiment of the invention, an improved vehicle load protection pad is provided including an elongated, resiliently deformable body. The pad further includes a flexible mat attached to the body; and a plurality of magnets disposed within the mat for attaching the body to a surface of a vehicle. The body includes a foam core and the magnets are located in staggered positions within the mat.

The flexible mat includes at least one flap having at least some of the magnets disposed therein and at least one fold in the mat to accommodate bending the flap.

The flexible mat includes a base attached to the deformable body, two flaps located on opposite sides of the base, and folds in the mat between the base and each flap. The magnets are distributed in staggered positions within each flap.

The pad includes a means for fastening the pad to another similar pad, whereby adjacent pads are mechanically connected end-to-end. The fastening means includes hook and loop fasteners connecting adjacent pads.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is an orthogonal view of several protection pads embodying the present invention placed at various locations on a motor vehicle;

FIG. 2 is an orthogonal view of a protection pad embodying the present invention;

FIG. 3 is an orthogonal view of two protection pads embodying the present invention placed adjacent one another;

FIG. 4 is a side elevational view of the pads of FIG. 3;

FIG. 5 is a side elevational view of one end of the pad of FIG. 2 with the flaps shown in various positions;

FIG. 6 is a partially exploded view of the pads of FIG. 4 taken along line 6 of FIG. 4;

FIG. 7 is a top plan view of a protection pad embodying the present invention with magnets shown in phantom;

FIG. 8 is a bottom plan view of the protection pad of FIG. 7;

FIG. 9 is a side elevational view of the protection pad of FIG. 5; and

FIG. 10 is a cross-sectional elevational view of the protection pad of FIG. 7.

### DETAILED DESCRIPTION OF THE PREFERRED EMBODIMENT

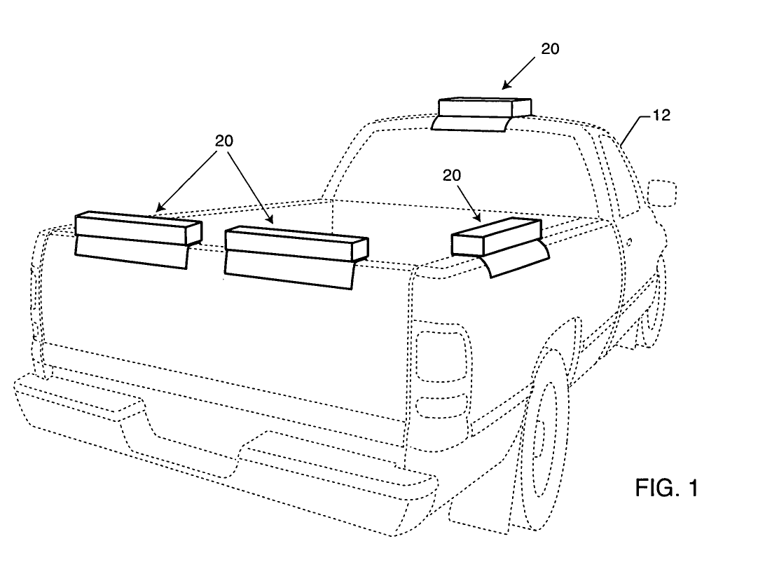

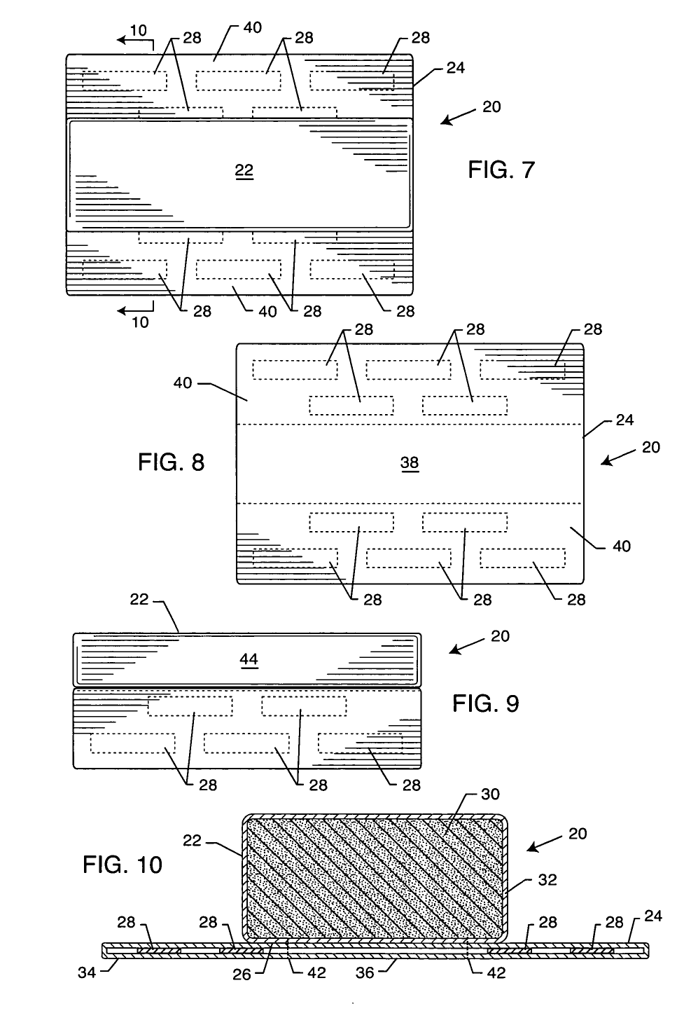

As illustrated in FIGS. 1-10, the present invention resides in an improved vehicle load protection pad 20 including an elongated, resiliently deformable body 22. The pad 20 further includes a flexible mat 24 adjacent to a bottom surface 26 of the body 22. The pad 20 is generally rectangular in shape.

A plurality of magnets 28 are disposed within the mat 24 for attaching the body 22 to a surface of an object, such as a motor vehicle. The magnets 28 are disposed in staggered positions within the mat 24.

The body 22 is elongated, generally rectangular in shape, and includes a foam core 30 surrounded by a washable, water-proof exterior shell 32. The shell 32 may be made of any durable synthetic or natural material. For example, the shell 32 may be made of a single layer of waterproof canvas or, alternatively, several layers of waterproof canvas with a layer of foam between the layers and/or the shell 32 may be made of neoprene or other materials used in the manufacture of wetsuits or computer mousepads.

The mat 24 is elongated, generally rectangular in shape, and includes a washable, water-proof exterior shell 34. The bottom side 36 of the shell 34 is covered with a non-slip material that allows the mat 24 to be non-slip when the bottom side 36 of the mat 24 comes in contact with the surface of a motor vehicle 21, the ground or other surface upon which the mat 24 rests. The shell 34 may be made of any durable synthetic or natural material. For example, the shell 34 may be made of a single layer of waterproof canvas or, alternatively, several layers of waterproof canvas with a layer of foam between the layers and/or the shell 34 may be made of neoprene or other materials used in the manufacture of wetsuits or computer mousepads.

The flexible mat 24 includes a central portion or base 38 and at least two flaps 40 located on opposite sides of the mat 24. In order to accommodate bending the flap 40, each flap 40 bends along at least one fold 42 in the mat 24 located between the base 38 and the flap 40. As seen in FIG. 5, the flaps 40 are movable between several positions and the flexibility of the flaps 40 allow the flaps 40 to adapt to the configuration of the surface upon which the pad 20 rests (see FIG. 1). The flexibility of the flaps 40 allows the flaps 40 to be bent towards the body 22 along one edge of the body 22 if necessary. The flexibility of the flaps 40 also allows the flaps 40 to generally conform to the attachment surface upon which they are placed so that magnets 28 within the flaps 40 can be positioned for maximum attachment area to the surface. Alternatively, ribs or slats (not shown) may be inserted within the flaps 40 to increase the resiliency of the flap 40 to return the flap 40 a generally planar configuration when the magnets 28 are released from a metallic surface. In another alternative, one or more ribs or slats may be inserted across the width of the mat 24 to increase the resiliency of the mat 24 itself so that the mat 24 returns to a generally planar configuration when the magnets 28 are released from a metallic surface.

The width of the base 38 is less than that of the body 22 such that each fold 42 is located anywhere between the center of the body 22 and the edge of a sidewall 44 of the body 22. The magnets 28 are distributed in staggered positions within each flap 40.

The base 38 of the mat 24 is mechanically attached to the body 22 by stitching (not shown) along the folds 42. Alternatively, the base 38 of the mat 24 may be adhesively connected to the body 22. In another alternative, the base 38 may be mechanically connected to the body 22 by a variety of fasteners including, without limitation, metallic snaps, plastic snaps and/or hook and loop material (e.g., VELCRO).

The magnets 28 are positioned within the mat 24 by sewing around the magnets 28 or adhesively attaching each magnet 28 in position within the flaps 40. Alternatively, the shell 34 may be constructed such that a number of pockets (not shown) may be formed within the shell 34 where each pocket receives a magnet 28. In another alternative, the interior of the shell 34 may include several layers of material, identical or similar to the ones mentioned above, one of which is a cushion layer (not shown) of a foam-like material, such as rubber foam, to provide a cushion between the pad 20 and the surface upon which the pad 20 rests. This cushion layer may also act as an additional water impermeable moisture barrier.

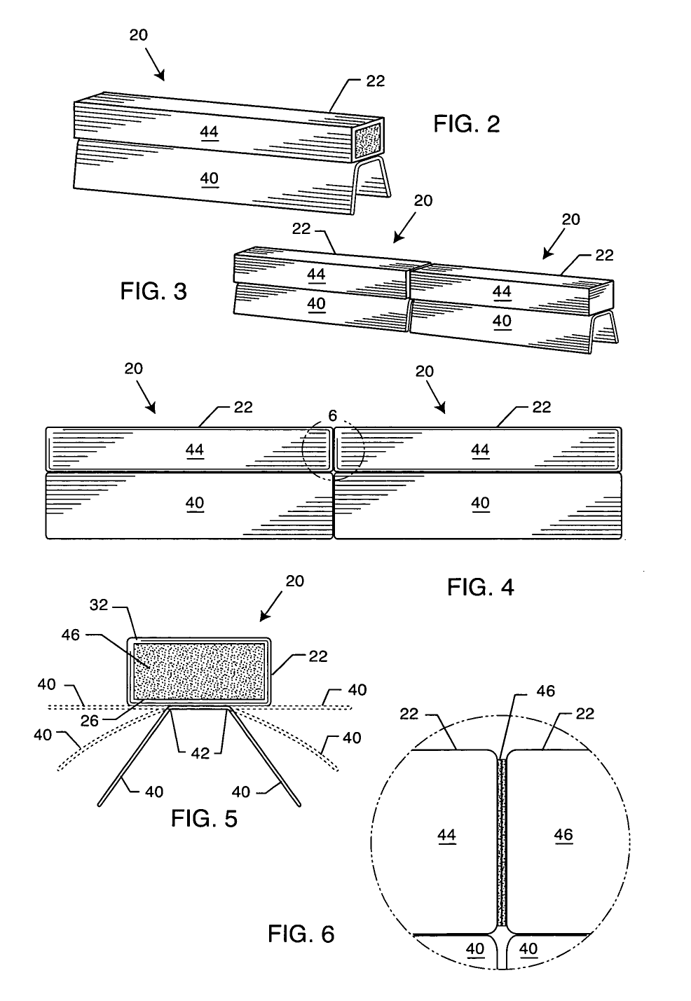

The pad 20 includes fasteners 46 for removably connecting the pad 20 to another similar pad 20. This allows adjacent pads 20 to be mechanically connected end-to-end. The fasteners 46 include, without limitation, metallic snaps, plastic snaps and/or hook and loop material (e.g., VELCRO) (see FIGS. 2-6). Alternatively, various surfaces of the pad 20 can be covered with hook and loop fasteners so that when the pad 20 is ready to be stored, the hook and loop fasteners on the surfaces of the pad 20 can be pressed against each other to hold the pad 20 in a closed configuration.

Alternatively, a layer of material (not shown) (e.g., a towel) may removably attached to the top surface of the mat 24. The towel may be attached to the mat 24 using a variety of fasteners including, without limitation, metallic snaps, plastic snaps and/or hook and loop material (e.g., VELCRO). For example, a patch of VELCRO may be placed near each corner of the mat 24. A mating patch of VELCRO may be placed near each corner of the towel on the bottom surface of the towel so that the towel may be attached to the mat 24. The towel is removable for washing and may be made from any synthetic or natural material. The towel can include indicia, such as a person's name, the logo of a sponsor, and/or a company's name. Similar indicia may also be placed on the shells 32, 34.

Alternatively, at least one pocket (not shown) may be removably connected to at least one surface of the body or mat shells 32, 34. The pocket is connected to the shell 32, 34 using a variety of attachment devices (not shown) including metallic snaps, plastic snaps and/or hook and loop material (e.g., VELCRO). In another alternative, the pocket may be sewn directly to the shell 32, 34.

In yet another alternative, a reflective surface (not shown) can be adhered or fastened to the front edge of the pad 20 that would be able to attach, using the magnets 28, to the back of a vehicle 21 when the vehicle 21 is broken down on the side of the road.

In use, the pad 20 is positioned on a pickup truck to protect the roof of the cab and/or to protect the upper edge of the truck's tailgate sidewalls, as seen in FIG. 1. The shape of the pad 20 is sufficiently flexible to overlie the area to be protected. The pad 20 protects against loads scratching or denting the tail gate or cab of a truck's 21 leading edge when those loads lay against these surfaces. The pad(s) is/are placed in position such that the body 22 is located upward from the mat 24. The flaps 40 of the mat 24 are then positioned to overlie the area to be protected. The magnets 28 within the flaps 40 then magnetically adhere to the metallic surfaces of the truck 21 over which they are positioned. Although not shown, when a user is working on the vehicle's 21 engine, a pad 20 can be positioned over and magnetically adhered to the front fender of the vehicle 21 when the hood of the vehicle is raised so that the user may lean over the front fender without damaging the surface from contact scratching while working on the engine. The pad 20 also protects the fender surface from coming into contact with any fluids while the user is working on the engine. When finished with the hauling, engine repair or the like, the pad(s) 20 can be easily disconnected from the vehicle 21 by lifting the flaps 40 away from the metallic surface and breaking the magnetic hold between the magnets 28 and the metallic surface.

The pad 20 can also be used for a variety of other applications including, without limitation, a kneeling pad for changing a tire, a pad for fender protection when working under the hood of a vehicle, a car top carrier for skis, snowboards, surfboards, etc. placed on the top of a car.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

1. A vehicle load protection pad, comprising:
an elongated, resiliently deformable body;
a flexible mat attached to the body; and
a plurality of magnets disposed within the mat for attaching the body to a surface of a vehicle.

2. The vehicle load protection pad of claim 1, wherein the flexible mat includes at least one flap having at least some of the magnets disposed therein.

3. The vehicle load protection pad of claim 2, including at least one fold in the mat to accommodate bending the flap.

4. The vehicle load protection pad of claim 1, wherein the flexible mat includes a base attached to the deformable body, and two flaps located on opposite sides of the base.

5. The vehicle load protection pad of claim 4, including folds in the mat between the base and each flap.

6. The vehicle load protection pad of claim 4, wherein the magnets are distributed in staggered positions within each flap.

7. The vehicle load protection pad of claim 1, wherein the magnets are located in staggered positions within the mat.

8. The vehicle load protection pad of claim 1, including means for fastening the pad to another similar pad, whereby adjacent pads are mechanically connected end-to-end.

9. The vehicle load protection pad of claim 8, wherein the fastening means includes hook and loop fasteners connecting adjacent pads.

10. The vehicle load protection pad of claim 1, wherein the body includes a foam core.

11. A vehicle load protection pad, comprising:
an elongated, resiliently deformable body including a foam core;
a flexible mat attached to the body and including at least one flap and at least one fold in the mat to accommodate bending the one flap; and
a plurality of magnets disposed within the mat for attaching the body to a surface of a vehicle, wherein at least some of the magnets are disposed in the flap.

12. The vehicle load protection pad of claim 11, wherein the flexible mat includes a base attached to the deformable body and two flaps located on opposite sides of the base, and folds between the base and each flap.

13. The vehicle load protection pad of claim 12, wherein each flap includes magnets distributed in staggered positions therein.

14. The vehicle load protection pad of claim 11, wherein the magnets are located in staggered positions within the mat.

15. The vehicle load protection pad of claim 11, including means for fastening the pad to another similar pad, whereby adjacent pads are mechanically connected end-to-end.

16. The vehicle load protection pad of claim 15, wherein the fastening means includes hook and loop fasteners connecting adjacent bodies.

17. A vehicle load protection pad, comprising:
an elongated, resiliently deformable body including a foam core;
a flexible mat attached to the body and including a base attached to the deformable body and two flaps located on opposite sides of the base, and folds between the base and each flap; and
a plurality of magnets disposed within each flap for attaching the body to a surface of a vehicle, wherein at least some of the magnets are disposed in staggered positions in each flap.

18. The vehicle load protection pad of claim 11, including means for fastening the pad to another similar pad, whereby adjacent pads are mechanically connected end-to-end.

19. The vehicle load protection pad of claim 15, wherein the fastening means includes hook and loop fasteners connecting adjacent mats.
